(19) United States
(12) Patent Application Publication
(10) Pub. No.: US 2004/0135819 A1
(43) Pub. Date: Jul. 15, 2004

(54) Computer remote control

(76) Inventor: Shalong Maa, Dallas, TX (US)

Correspondence Address: Shalong Maa, Ph.D., P.O. Box 117015, Carrollton, TX, 75011, US

(21) Appl. No.: 10/688,269

(22) Filed: Oct. 20, 2003

Related U.S. Application Data
(60) Provisional application No. 60/421,493, filed on Oct. 28, 2002.

(51) Int. Cl. G09G 5/00

(52) U.S. Cl. 345/840

(57) ABSTRACT

Disclose herein are apparatus, methods and systems for computer remote control. According to the present invention, the user-interface of a conventional window-desktop system can be modified such that a user may use any type of input device, such as a handheld remote-control device or a mouse, to fully and conveniently interact with the desktop-window computer system. This is accomplished by taking full advantage of the flexibilities of software programming of a computer system according to the present invention. For example, after receiving a user input for displaying a display item, the interface system of the present invention will cause such a display item to be displayed on a display, and in the meantime, also cause the cursor to be located at said display item; thus the user is not always required to manually use the input device to quickly and precisely place the cursor at the desired position.

This Application claims the benefits of U.S. Provisional Application No. 60/421,493 filed Oct. 28, 2002 and U.S. Provisional Application No. 60/401,795 filed Aug. 7, 2002, of which the complete disclosures are incorporated fully herein by reference.

### FIELD OF THE INVENTION

The present invention pertains generally to user-friendly computer interface system and, in particular, to remote-control computer interface system that allows a user to conveniently interact with a computer-window operating system and any application program supported or executed thereby using a handheld remote-control device.

### BACKGROUND OF THE INVENTION

With the increasing popularity of interactive electronic networks, such as the Internet and the World Wide Web, and the advent of digital video technologies, the services of providing integrated multimedia interactive entertainment systems are drawing more attention in the market place. It is known in the art that, a fully interactive TV-entertainment system requires the functionalities of a mouse-window type computer operation system such that, for example, a streaming video received from a TV-broadcasting system can be displayed within a computer window. However, the prior art does not provide any convenient remote-control system that allows a user to use a handheld remote-control device as a user input means for fully interacting with the display of a window-base multimedia computer. As a result thereof, a user is required to sit very close to the display or monitor of the computer so as to use a mouse as input device to interact with the contents provided thereby.

It is well known that, the conventional mouse-window type desktop computer system has the very unique and important user-interface feature of allowing a user to use a mouse to conveniently, quickly, easily, and very precisely place a cursor (i.e., an input-device indicator) at or move it to any position on a display of the computer system. The failures of the prior art computer remote control systems result, in part, from the facts that, (i) Almost all of the existing desktop computer application programs are designed based on such a user-interface feature; (ii) It is very difficult to match such user-interface feature of mouse-window type desktop computer system using other type of input device (e.g. remote-control device) for cursor control, regardless of how complex the input device is made; and (iii) The prior art fails to take full advantage of the flexibilities of software programming of a computer system.

### SUMMARY OF THE PRESENT INVENTION

To remedy the foregoing and other drawbacks of the prior art and to achieve other objects of the present invention, there are provided and disclosed herein novel computer remote control methods an apparatus. As described above, it would be difficult to employ a handheld remote-control device to replace the mouse as an input device of a desktop computer system while still providing the user-interface feature of allowing a user to conveniently, quickly, easily, and very precisely place the cursor at or move it to any position on the display of the computer system. The solution thereto, according to the present invention, is to modify the user-interface of the desktop computer system such that, a user can use an input device to fully and conveniently interact with the conventional desktop-window computer system without being required to always use the input device to quickly and very precisely place the cursor at or move it to any position on the display of the computer system. This is accomplished by taking full advantage of the flexibilities of software programming of a computer system according to the present invention. For examples, after receiving an user input for displaying a display item, such, for examples, as a menu or an application tool bar, within a predefined area on a display, the computer interface system of the present invention will cause such a display item to be displayed within said predefined area on said display, and in the meantime, also cause the cursor to be displayed within said predefined area; Thus, it is not necessary for the user to use the input device to move the cursor from another position to said predefined area on the display. Those skilled in the art would appreciate that, the user-interface system of the present invention allows a use to fully interact with a widow-desktop computer system using both mouse and handheld remote-control device as input device, since the mouse-based and remote-control-based window-desktop user-interface modes, according to the present invention, may only have minor differences, and a user can easily switch the two modes with click of a button.

The foregoing is intended to be merely a summary, and not for limiting the scope of the present specification. The features of the invention that are believed to be novel are set forth with particularity in the claims. The invention, together with further objects and advantages thereof, may best be appreciated by reference to the following detailed description taken in conjunction with the drawings.

### BRIEF DESCRIPTION OF THE DRAWINGS

FIG. 1 is a schematic representation of an exemplary multimedia home entertainment computer system for implementing the methods of the present, wherein an exemplary simplified TV broadcasting and client-server network system for providing synchronized interactive contents to the multimedia home entertainment system is also illustrated.

FIG. 2 is a diagrammatic representation of an exemplary handheld remote-control device for interacting with the multimedia home entertainment system of FIG. 1 using the computer remote-control methods of the present invention.

FIG. 3 illustrates an exemplary window desktop display according to the present invention.

FIGS. 4-6 and 8-9 are displays of exemplary computer windows for illustrating methods of using the remote-control device of FIG. 2 to interact with the multimedia system of FIG. 1 according to the present invention.

FIG. 7 is a schematic illustration of an exemplary virtual rectangle for arranging application-tool buttons of an application program so as to provide instruction for displaying the application-tool buttons within an application-tool window of FIG. 6 according to the present invention.

FIGS. 10-12 are simplified exemplary diagrams for illustrating the CMFT video image compression method according to another aspect of the present inventions.

### DETAILED DESCRIPTION OF THE INVENTION

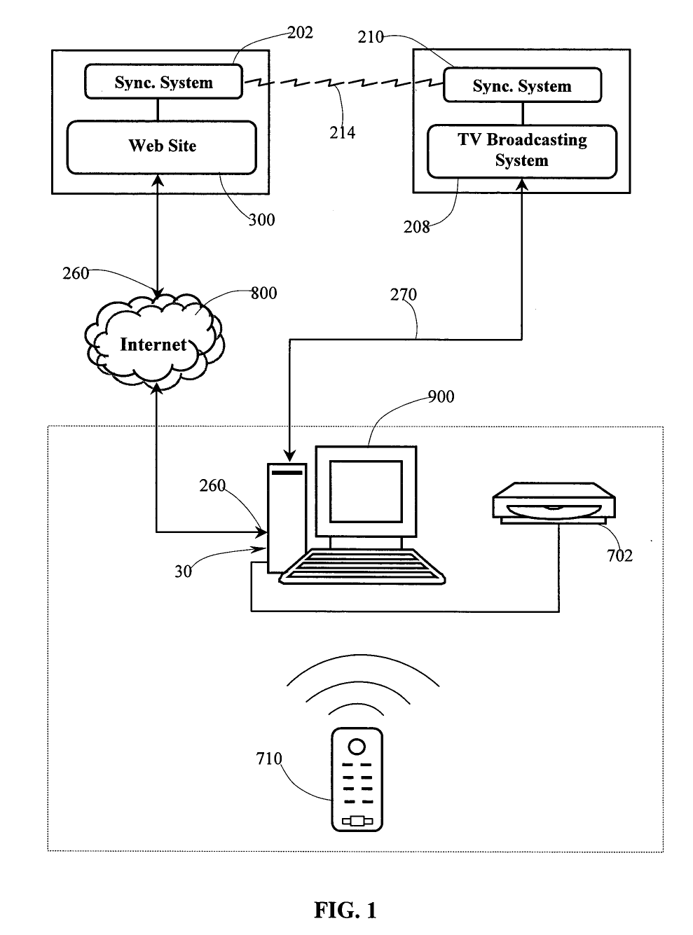

Referring to FIGS. 1-9, there are shown new and novel computer remote-control methods, apparatus, and systems embodying the concepts of the present invention. While the present invention is susceptible to embodiments in various forms, there is provided detailed description of the presently preferred embodiments, with the understanding that the present disclosure is to be regarded as exemplifications, and does not limit the invention to the specific embodiments illustrated. In some instances, for purposes of explanation and not for limitation, specific reference or other numbers, diagrams, or dimensions, etc., may be set forth in order to provide a thorough understanding of the invention. In other instances, detailed descriptions of well-known elements or electronic circuitry or computer or network components are omitted so as to not obscure the depiction of the invention with unnecessary details. In case when alternate arrangements of an element or component are described or displayed, like parts or components may be assigned with the same numerical reference numbers.

Referring first to FIG. 1, a home entertainment system may include an Internet enabled multimedia client computer 30, and a hand-held remote control device 710 for control of all other elements of the entertainment system. In addition, the entertainment system may also include other type of electronic devices, such as a toy figure, a CD or DVD player, a sound system, etc., that are controlled by the computer 30 and by the remote control 710; In FIG. 1, these electronic devices controlled by the computer 30 and by the remote control 710 are represented generally by the device 702. The computer system 30 is provided with a display 900, such as a computer monitor or a large screen TV, and may include a TV turner component such that both the computer/Internet contents received from a web site 300 and TV programs or streaming videos 270 received from a TV broadcasting center 208 can be displayed on the display 900. As shown, the computer 30 is connected to the web site 300 via the Internet 800. The streaming video 270 may also be transmitted to the computer 30 from the web site 300 through the Internet. It is preferred that the Web site 300 and the TV broadcasting system 208 are provided with synchronization systems 202 and 210 respectively such that the TV contents provided by the broadcasting system 208 can be made interactive. As it is well know in the art, the Web site 300 usually includes a Web server processing system for serving or providing Web content such as a video or video clip or a HTML document requested by the client computer 30; in a standard request-response process for viewing a graphical content by the client, the client system 30 specifies the URL or IP address of said content in a request, which is forwarded to the corresponding Web site 300 supporting such content; in response thereto, the Web server 300 will send the requested content to the client 30. Typically, the Web site 300 also includes application or programming system and database system for implementing a business entity's various business applications.

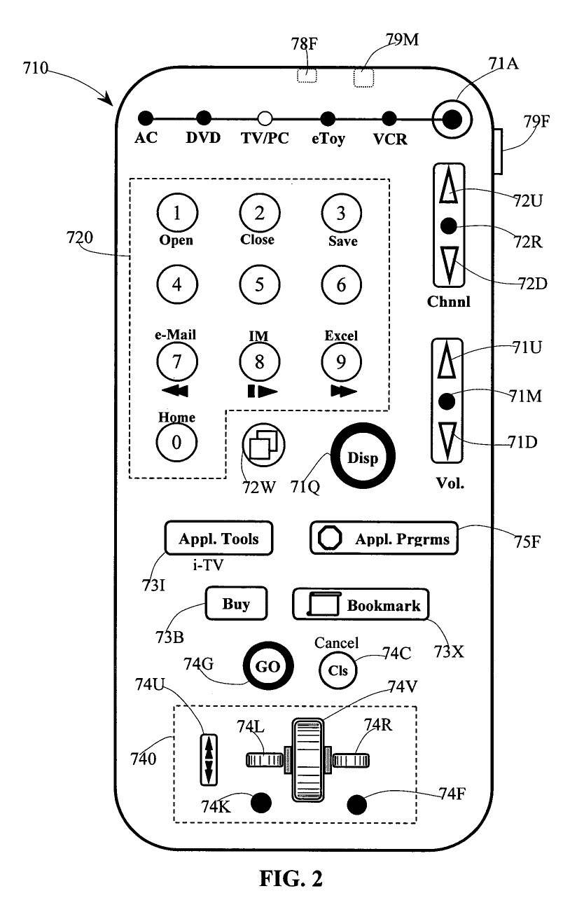

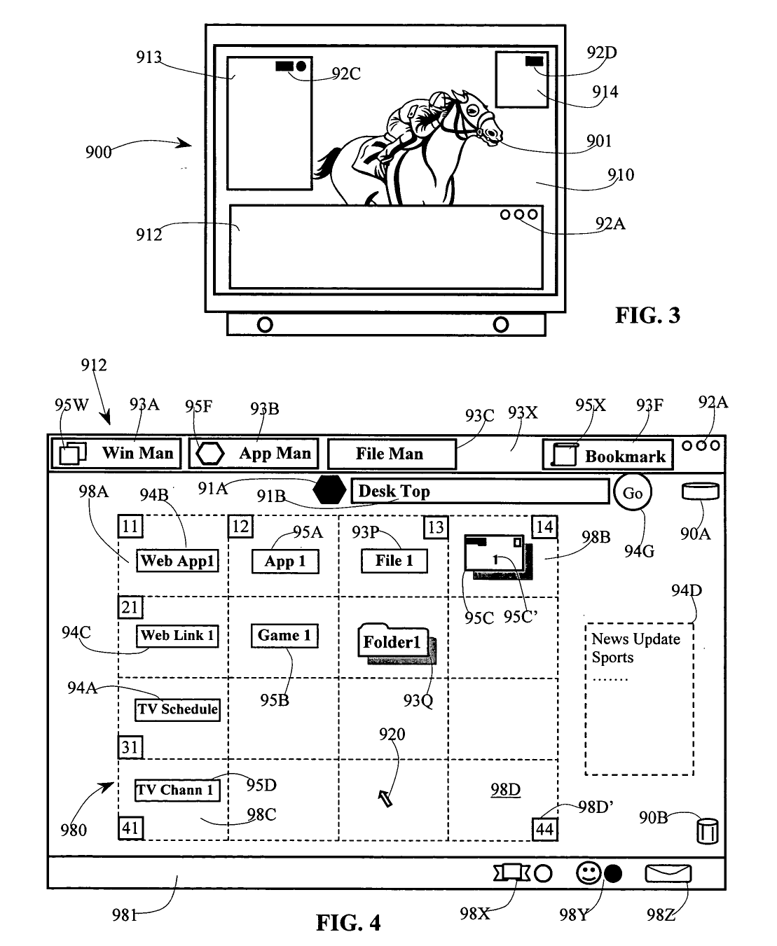

Reference is now made to FIGS. 2-3 in conjunction with FIG. 1. As shown therein, the user control of the multimedia entertainment system of FIG. 1 is provided by a handheld remote control device 710. The remote control 710 includes computer and Internet/web-browser operation buttons and display-control/scrolling means (as described below), a conventional number/letter button assembly 720 for TV-channel selection, TV-channel changing buttons 72U and 72D for increasing and decreasing the current TV channel number respectively, a TV channel return button 72R, and conventional volume control buttons 71U and 71D and a mute button 71M. Alternatively, a conventional VCR-, CD-, or DVD-type media-player operation assembly that includes “play”, “fast forward”, “fast reverse”, “pause”, and “stop” buttons, etc. may also be included on the remote control device 710.

It is understood that, the foregoing conventional TV control buttons may also be employed for interacting with other components of the multimedia system of FIG. 1, and that, some of said “conventional” TV control buttons may also be used for computer operations. For examples, (i) In addition to the function of conventional TV channel selection, the number/letter buttons 720 may also be used to provide access to a computer application program, as described in details herein below; and (ii) The channel return button 72R may be used for controlling the currently active computer-TV window by switching the display content therein back to the previously viewed TV channel, etc. The remote control 710 may (optionally) includes a device-selection button 71A for selecting which device (i.e., e.g., whether it is the TV, VCR, AC, DVD, or e-Toy, or the currently active window of the Computer system 30, etc.) is to be currently controlled by the remote control 710 and/or by the computer 30.

It is appreciated that, the basic concepts of computer remote control of the present invention include, (i) a simple remote control operation will instruct an active window to display a display item, such as a listing of application buttons or links (e.g., a toolbar, a bookmark listing, or a menu, etc.), and in the meantime, causing the cursor to be displayed on such display item so as to facilitate the user's desired action of easily browsing through and clicking on one of the application buttons or links so listed; (ii) a limited number of press-button combinations on the remote control 710 will provide unlimited shortcut means for easy access to the user's desired applications or commands; and (iii) the press-buttons of the remote control 710 are arranged in such a way that they provide a user with intuitive means to interact with window-based computer multimedia system.

It is preferred that, (i) the remote control 710, as shown in FIG. 2, includes a display buttons 71Q for display control, such, for examples, as opening/closing a window on the display 900, or displaying or expanding a menu (see below), etc., by interacting with the Computer operation system 30 via wireless signals, and that (ii) the function of TV channel selection and other conventional TV operations are the default functions provided by the number buttons assembly 720, since almost all users already have extensive experience of using a remote-control device to interact with TV. For examples, (i) in order to display TV channel 7 within a new TV-window 913 (i.e., window No. 6 or VI) on the display 900 (see FIG. 3), a user will depress the display button 71Q and then the number button “6” of the remote control 710 for opening a new window 913 on the display 900, then the user can press the number button “7” for displaying the TV channel 7 within the TV-window 913; and (ii) if the user presses the number button “7” without depressing the button 71Q or any other functional button there-before, the current active window will be switched to TV channel No. 7.

It is preferred, according to the present invention, that each window or TV-window displayed on the display 900 of the multimedia system 30 is provided with a simple window ID so as to facilitate remote control by a user. For example, as shown in FIG. 3, the windows 913, 912, and 914 are provided with, respectively, an ID 92C (i.e., a bar and a dot on right for indicating ID No. 6, which is similar to “VI”), an ID 92A (i.e., three dot, or III), and an ID 92D (i.e., a bar for indicating ID No. 5, similar to “V”), for indicating that they are window No. 6, 3, and 5 respectively. These window IDs 92A, 92C, and 92D may also service the purpose of indicating the currently “active” window, i.e., the window currently controlled by the remote control 710, by, for example, highlighting or brightening the ID of the active window (e.g., In FIG. 3, the currently active window is widow 912, as indicated by the window ID 92A). Apparently, (i) other methods, such for example as highlighting the frame of a Window, may also be used for indicating the currently active window, and (ii) other commonly used ID methods can be employed for the purpose of window identification. The window IDs can also allow a user to easily switch from one window to another window displayed on the display 900, or to close a window, using the remote control device 710.

Alternatively, two or more remote control devices may be provided for control of different windows displayed on the same display 900 and supported or controlled by the same computer system 30, in which case the computer and the remote control devices may be provided with device-identification systems/components such that a window opened by one remote control device will not response to control signals transmitted from other remote control device(s). Alternatively, if a multimedia system is provided with more than one remote-control devices, one or more of these remote-control device may be provided with higher control priority (the master remote control), i.e., a window opened by a non-master remote control can be controlled by a master remote control device, while a window opened by a master remote control will not response to a non-master remote control device.

As shown in FIG. 2, a cancel or close button 74C may be provided on the remote control 710 such that, for examples, (i) the combination of depressing the cancel/close button 74C and then the display button 71Q will close the current active window; (ii) if the currently active window is the TV-window 913 and the user wants to close the TV-window 912 (window ID No. 3), the user may then have two options, including: (a) using the combination of depressing the cancel/close button 74C and then the number button “3” on the remote control 710, or (b) switching from the TV-window 913 to the TV-window 912 by pressing the “Disp” button 71Q and the number button “3”, then closing the now active window 912 by the combination of depressing cancel/close button 74C and then the display button 71Q.

The TV signals 270 transmitted from the broadcast center 208 may include display instructions as to how many TV-windows are desired for a current TV program 901 displayed on the display 900, and/or the default size, position, and content of each such TV-window. A web page or web content associated and/or in synchronization with the current TV program may (i) provide sub-content information relating to the TV program (e.g., stats information or different camera angle for a live sport event), and/or (ii) include web links or application links that are related to the TV program. Such a web page/content associated with the current TV program may be displayed within a separate window on the display 900; clicking through any web/application link therein using the remote control 710 will cause the associated contents be displayed within a designated or newly opened Window.

It is preferred that the TV-computer operation system 30 is a web-browser based operation system, i.e., the full functionality of a conventional web browser is integrated or incorporated into the basic functionality of the operation system 30. Accordingly, the remote control 710 is provided with short-cut press buttons for interacting with the web-browser functions of the TV-computer system 30.

It is preferred that the remote control 710 includes a “bookmark” button 73X, as shown in FIG. 2, for adding a web page into the bookmark list (or the like) of the computer system 30's web browser. The bookmark function of the remote control 710 can be used to provide users with interactive TV experience if a TV program on the display 900 is provided with a synchronized web page/content by the web site 300. When the computer 30 receives the bookmark signal from the remote control 710, it will contact the web site 300 for obtaining the web page associated or synchronized with the current TV program and/or the URL or IP address thereof, and add such URL or IP address to the bookmark listing of the web browser, such that a user may later have access to interactive information provided thereby. It is preferred that, (i) if the currently active Window displays a TV program 901, depressing the “bookmark” button 73X will cause the web browser of the computer 30 to bookmark a Web page associated and/or synchronized with the current TV program 901, regardless of whether such web page is displayed within a window; and that (ii) if the currently active window on the display 900 displays a web page or web content, regardless of whether such web page/content is related to any TV content shown within any other windows on the display 900, depressing the “bookmark” button 73X will cause the web browser to bookmark such web page or web content so displayed. In some situations, a user's computer may not be connected to the Internet while, for example, watching a TV program on the display 900, and thus it would be impossible to immediately obtain the URL or IP address of the web page associated or synchronized with the current TV program; In which case, the information stored in the bookmark file of the computer 30 in response to receiving a bookmark signal from the remote control device 710 may only includes the name or channel number of the current TV program and the current timestamp; Then when the user later wants to have access to the associated web page to learn more information about such particular section of the TV program, the web site server 300 used for providing interactive contents for the TV program will be able to obtain such web page and sent it to back to the client 30 base on the TV-channel and the timestamp information received from the client computer 30.

It is also preferred that, the remote control 710 further includes a “buy” button 73B for facilitating online purchasing by activating an online identity-authentication/purchasing application installed in the computer 30. For examples, if a web page shown within a window on the display 900 includes a “purchase” item available for online purchasing, when a user press the “buy” button 73B to activate said online identity-authentication/purchasing application, it will cause the client computer 30 to contact the web site that supports such e-commerce transactions. As a result thereof, the related confirmation information, such as the price, name, shipping address, credit card account information, etc., and/or simple instructions, will be displayed on the display 900 within a designated window; the user can then press the “buy” button 73B again or a “go” button 74G (see below) on the remote control 710 to complete the transaction; Apparently, the system 30 may require that the user provide password information using, for example, the number buttons 720 on the remote control 710 before completing the purchasing process. If the current web page does not include any “purchase” item available for online purchasing, a brief message such as “no item available for online purchasing” may be displayed in response to user pressing the “buy” button 73B.

It is understood that, the web page or content associated or synchronized with a TV program and provided by a web site may also include TV-display instruction for instructing the TV-computer system 30 as to the desired size, position, and background color, etc. of the TV windows designated for the TV program and/or for any of its sub-contents. In one example, if the web content associated/synchronized with a TV program is a HTML- or XML-type web page, said TV-display instruction may be included in a HTML- or XML-type <tag> at the header or body section of such web page.

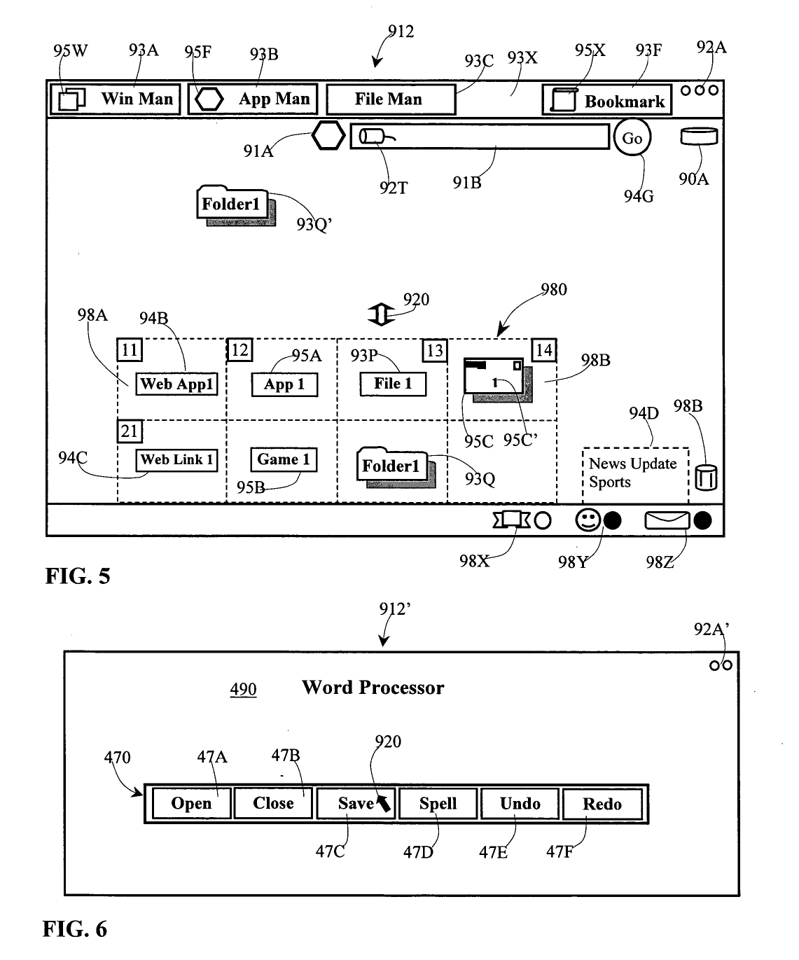

As shown in FIG. 2, the remote control 710 also includes a “Go” button 74G for interacting with or for activating a computer application program, a “cursor float” control button 74F for controlling the “floating status” of an input-device indicator or cursor 920 on the display 900 (See FIG. 4), and a cursor control assembly 740. As shown, the assembly 740 includes a vertical rolling wheel 74V and a pair of horizontal rolling wheels 74R and 74L. The vertical rolling wheel 74V is provided for controlling vertical-only content scrolling or cursor movement or the like on the display 900; the two horizontal rolling wheels 74R and 74L are provided for controlling horizontal-only content scrolling or cursor movement or the like. It is understood that, the main reason for having two horizontal rolling wheels 74R and 74L instead of one in the FIG. 2 example is for the purpose of providing geometric symmetry only. Alternatively, the remote device 710 may be provided with only one horizontal rolling wheel. It is also understood that, (i) the rolling wheels 74V, 74R and 74L of the FIG. 2 example shall be understood as one full rolling mechanism for providing the full function of content scrolling and/or for placing the input device indicator, or the cursor 920 of FIG. 3, to any position on the display 900, and that (ii) the horizontal rolling mechanism provided by 74R/74L may be replaced by a “sliding mechanism” or the like, such, for example, as having the wheel 74V mounted on a sliding bar such that moving the wheel 74V along such sliding bar will provide the same effect as the rolling wheels 74R/74L.

It is well known that, the conventional mouse has at least one full rolling mechanism, such as the trackball underneath the convention mouse. Some of the mouse-type input device, such as the so-called “intelli-mouse” marketed by Microsoft Corp., has two rolling mechanism, including a conventional trackball located at the underneath and a small rolling wheel on top of the mouse. The basic functions of the computer mouse as an input device includes: (i) cursor movement, i.e., moving the cursor to any position on a computer display, (ii) scrolling, i.e., scrolling contents displayed within a window if the window does not provide enough space for displaying the entire content of an application program; (iii) execution, i.e., executing or “clicking on/through” an display item, such as a command button, a link, an icon, a shortcut, a menu, etc., currently located by the cursor, which is accomplished by the “left click” button of the conventional computer mouse; (iv) command listing, i.e., providing a listing of commands or other items or properties associated with the display item currently located by the cursor, which is accomplished by the “right click” button of the conventional computer mouse; and (v) text-cursor control, i.e., placing the text-typing cursor at an desired position—the conventional window system employs a two-cursor system in a text-related application, such as a word-processor, wherein the text cursor is the position where text input is to be entered into the text field of the application; in many cases, the text cursor is separate from the mouse-movement cursor.

As described above, the “Go” button 74G of the remote-control device 710 provide the foregoing function of executing or “clicking on/through” of the conventional mouse; The rolling wheels 74V and 74R/74L provide the foregoing function of cursor movement and/or text-cursor control. Another button 74K is provided on the device 7 1 0 for providing the foregoing function of command listing or “right clicking” of the conventional mouse. Since a full rolling mechanism usually requires substantial space, it is preferred that a single full rolling mechanism, i.e., the rolling wheels 74V and 74R/74L of the FIG. 2 example, is used for providing both content scrolling and cursor movement functions (Alternatively, a vertical scrolling bar/rod or stick that can be operated by a user's thumb may be provided on the remote control 710 for providing content scrolling). This is accomplished by providing the cursor 920 and the rolling mechanism of the remote control device 710 with various “cursor-control/scrolling modes”. According to the present invention, the controlling and/or arrangement of such cursor-control/scrolling mode shall be based on (i) the type of user inputs received from the remote control 710, and/or on (ii) the type of application or contents displayed within the current window; The assignment of such cursor-control mode to each window content may be done either manually by a user or automatically by the computer interface system based on the type of contents or application within the window. For example, if the current window is a very long web page, the computer interface system may automatically assign the default cursor-control/scrolling mode of such application to a “fast-scrolling local” mode (see below). It is appreciated that such a cursor-mode-control system of the present invention provides an important advantage of allowing user to have easy access to display items/contents on the display 900, as described in detailed herein below. Since the cursor icon 920 is for indicating the functioning and user's manipulation of a user-input device, the status of the cursor may be reflected or indicated by the shape and/or color of the cursor icon 920.

It is preferred that the cursor 920 on the display 900 is provided with three basic floating status or modes, including a “floating mode”, a “local mode” and a “text-cursor mode”, which are related to the “depth” (or “floating depth”) of the cursor movement and are controlled by the button 74F of the remote control device 710. If the current application area located by the cursor 920 is not a text field for text input, pressing the button 74F will cause the cursor 920 to switch between said floating and local modes—i.e., the interface system will ignore the text-cursor mode; If the current application area located by the cursor 920 is a text field for text input, pressing the button 74F will cause the cursor 920 to switch among said floating, local, and text-cursor modes. The floating statuses of the cursor are defined as follows: (i) If the cursor 920 is in said floating mode, a user may cause the cursor 920 to move freely throughout the entire display area of the display 900 by operating the rolling wheels 74V or 74L/74R of the remote control, in which case, the cursor 920 is not restricted within a specific Window or application area on the display; (ii) If the cursor 920 is in said local mode, the cursor will provide scrolling and/or cursor movement functions for the respective local window application area (see below for details), and the cursor will usually be restricted within a local application window; (iii) The “text-cursor mode” is the conventional text cursor of a text field for text input; operating the rolling wheels 74V or 74R/74L will move such text cursor within a text field; the conventional text-selection function may be provided by operating the rolling wheels 74V or 74R/4L after double-clicking or while holding the Go button 74G (similar to holding the left button of a mouse) of the remote control 710; clicking the button 74C of the remote control 710 after text selection will delete the selected texts; etc.

It is also preferred, according to the present invention, that in parallel to said local, floating, and text-cursor modes, the cursor 920 is also provided with three modes relating to cursor/scrolling movement, including a “continuous mode”, a “leaping mode”, and a “fast-scrolling mode”—the status of the cursor 920 may be switched among these three modes by clicking a control button 74U on the remote control device 710. The definitions of these three modes are as follows: (i) the “continuous mode” is the conventional mode for continuous cursor movement; (ii) the “leaping mode” is for causing the cursor 920 to leap among the executable items displayed, i.e., the cursor will skip those non-executable item, so as to allow user to quickly locate the executable items displayed; as used herein, the term “executable item” means an item displayed that can allow a user to execute a desired command or a program or an action, by click on the item, or to input text, such as a web link, an application icon or shortcut on the desktop, a file/folder icon or shortcut, an application-tool button, a text field for text input, etc.; and (iii) the “fast-scrolling mode” is for providing the function of fast scrolling of any display contents within a window or sub-window. It is understood that the cursor status controlled by the button 74F are parallel to the cursor status controlled by the button 74U of the remote control 710; Thus, there are total of nine (9) cursor-control/scrolling mode available, including: continuous floating, continuous local, continuous text-cursor, leaping floating, leaping local, leaping text-cursor, fast-scrolling local, fast-scrolling floating, and fast-scrolling text-cursor modes. Apparently, other type of cursor-control/scrolling mode may also be provided, depending the nature or character of each individual application program. Some of these modes, such as the fast-scrolling floating and the leaping text-cursor modes, may never be use or be ignored by the computer interface system—i.e., when in the floating mode, the interface system may ignore the fast-scrolling mode; when in the text-cursor mode, the leaping mode may be ignored by the interface system, etc. In one example, it is preferred that when the cursor is located at a text field, it is automatically switched to the continuous text-cursor mode by the interface system. It is preferred that, the computer interface system of the present invention will determined the optimal cursor-control/scrolling mode for each application or content within a window; or Alternatively, a user may set the cursor-control/scrolling mode for each application manually. For examples, (i) if the application is a word processor, the interface system may set its default cursor-control/scrolling mode to the “continuous text-cursor” mode, and ignore all the leaping modes, and regards the “local mode” and the “continuous mode” as the same; (ii) if the contents within a window are application-tool buttons of an application program, the interface system may set its default cursor-control/scrolling mode to the “continuous local” or “leaping local” mode (see below), and ignore the text-cursor mode; (iii) If the application is a relatively short web page that is displayed fully within a window, the interface system may set its default cursor-control mode to the “leaping floating” mode; etc.

The control of any new or application-specific cursor-control/scrolling modes added for a specific application program may be provided by “Double clicking” the button 74F; Alternatively, the remote-control device 710 may be provided with another button for control of any new cursor-control/scrolling modes added for a specific application program. Also alternatively, the rolling wheel 74V and the button 74F may be combined such that clicking on the wheel 74V will provide the same effect as depressing the button 74F, so as to reduce number of button on the remote-control device 710. In the FIG. 2 example, a window-control button 72W is provided on the remote control 710 such that, (I) double-clicking the button 72W will cause the cursor 920 to be in a window-size adjusting mode such that operating the rolling wheels 74V and/or 74R/4L of the remote control 710 thereafter will change the size of the current window; doubling clicking the button 72W again will cause the cursor 920 to be in its previous mode; and (II) It is preferred that each window on the display 900 is provided with at least three “display modes”, including: (i) a full-screen mode—i.e., full-screen display of the window without showing any toolbar, (ii) a full-screen toolbar mode—i.e., full-screen display of the window with the showing of some or all toolbars provided therefore, and (iii) a reduced-size non-toolbar mode—i.e., the display of the window is smaller than the full screen as desired without showing the toolbars (alternatively, a reduced-size toolbar mode may also be added thereto, which may be done at user's option); depressing the button 72W of the remote control 710 will cause the window to switch amount these display modes; Other window-display modes, such as transparent/non-transparent modes, or window-position-control mode for permitting/facilitating using the rolling wheels 74V and/or 74R/4L of the remote control 710 to change the position of an entire window on the display 900, may also be included therein, or be included in a “right-clicking” listing of an window that is to be listed and be available for use when a user “right-click” a mouse or press the button 74K of the remote control device 710 when pointing the cursor 920 to the frame of the window. It is understood that a window, according to the present invention, may be transparent such that, for example, a web page associated/synchronized with a current TV program may be overlaid or displayed on top of such TV program displayed (i.e., there are two layers of display contents), so as to provide the function of allowing a user to click on a display item that is provided by the web page but appears to be provided by the TV program.

It is preferred that while in said fast-scrolling local mode, the cursor 920 provides two functions: (1) if the respective local application content is not fully displayed within the current window, operating the rolling wheels 74V or 74L/74R will scroll the application contents within the window, i.e., moving the view of the local application content such that a hidden portion of the content is displayed within the window; and (2) after scrolling to an end of the display content of the application within the window, the cursor 920 itself will then start to move within said the window if the user repeats the same rolling wheel operation. In the FIG. 5 example, a new icon for the cursor 920 (as compared with the cursor 920 of FIG. 4) indicates that the cursor is now in the fast-scrolling local mode; After the content of the window 912 reach its top end (as shown in FIG. 5, a file folder 93Q′ is located at the top portion of the widow 912, as compared with FIG. 4), the cursor 920 itself starts to move upwardly (as compared with FIG. 4) when the user repeats the same operation of rolling the wheel 74V upwardly. For the purposes of window control, the tool bar or menu bar area of an application or window can be regarded as a window or a sub-window. It is preferred that, clicking on an “Application Tools” button 731 provided on the remote control device 710 will cause the application tool buttons of an current application program to be displayed within a predefined area (see FIG. 4) (Note that, it may include one or more than one row(s) of application-tool buttons) and in the meantime, caused the cursor 920 to be displayed at such application-tool area, and cause the cursor 920 to be in said “leaping local mode”, so as to allow a user to navigate or browse through the menu/tool bar area window/sub-window—If the menu or toolbar sub-window does not show all the available buttons, rolling the wheels 74V or 74L/74R will first cause the cursor 920 to browse through each individual application-tool buttons displayed; After the cursor 920 reaches the boundary of such application-tool sub-window, if the user repeats the same rolling wheel operation, it will cause the entire menu or toolbar to slide horizontally and/or to roll vertically (i.e., scrolling) such that more application-tool button can be displayed within the sub-window. Alternatively, another set of navigation/scrolling buttons or vertical stick may be provided on the remote control 710 such that the operating thereof by a user will cause said entire menu or toolbar to slide horizontally or to roll vertically first before causing the cursor 920 to browse through each individual application button.

The display 912 of FIG. 4 is an exemplary desktop window display according to the present invention, which includes an interactive section 94D for display of live or updated information provided by a web site, such as sports/news update, email update, live stock market data or quote, etc. An icon within the window 912 may also be made interactive. For examples, an Email icon 95C and the number 95C′ therein indicate that there is currently one new email received. As shown, some of the application or web link or file icons displayed within the window 912 are arranged within a four by four matrix 980. Each matrix cell includes one display item, and is identified by a matrix ID number. As shown, the ID numbers 11, 14, 41 and 44 are assigned to the matrix cells 98A, 98B, 98C, and 98D respectively, so as to facilitate easy identification of each matrix cell and to allow a user to use the number keys 720 in combination with a function/program key 75F provided on the remote control 710 to have easy access to the items associated with or displayed within these matrix cells (see below). In addition, the desktop window 912 of FIG. 4 also includes a hard drive icon 90A and a trashcan icon 90B, which may be partially visible through an application content within the widow for graphically indicating user's actions of, respectively, saving and deleting of files and/or data. In addition, the following items are included within matrix 980: a file shortcut 93P, a web link 94C, a web application icon 94B, a file folder shortcut 93Q, a web-based TV schedule link 94A, a TV channel-1 selection icon 95D (i.e., clicking on the icon 95D will cause the current window to switch to TV channel No. 1), a shortcut 95A for an application, and an icon 95B for a computer game. The window 912 of FIG. 4 also include a “Go” icon 94G such that clicking on the icon 94G will have essentially the same effect as depressing the “Go” button 74G of the remote control 710. The icon 94G may also provide a visual effect that the “Go” button 74G of the remote control 710 have been pressed.

The window 912 may also includes an alert component 981, which may be situated, for example, at the bottom of the window 912, as shown in FIG. 4. The alert component 981 shown includes an email-alert icon 98Z for indicating whether there is any urgent email; a deadline alert icon 98X for indicating whether a bill-pay or other type of deadline is getting close; and an appointment alert icon 98Y, which may be associated with a web-based calendar application, etc. When there is no alert, the area 981 may automatically hide. One skilled in the art would appreciate that such type of alert component may be provided for any type of web browser or window applications. In addition, the window 912 of the FIG. 4 example also includes a “command input” text field 91B for user to input a file name, an application, or a web page URL, etc., with the status thereof being indicated by an indicator 91A. When the indicator 91A is “on”, it indicates that the field 91B is ready for receiving a command. For example, if a user want to view a web page linked thereto by the “Web Link 1” 94C, which is located within the matrix 980 at cell ID No. 21 of the window 912 of FIG. 4, he can first click the “Appl. Prgrms” button 75F, and then the number buttons “2” and “1” on the remote control 710, which will cause the web page name or URL associated with the “Web Link 1” be displayed within the command input field 91B. Thereafter, the user can press the “Go” button 74G of the remote control 710 to view such web page. If the user decides that he made a mistake and wants to input another application, such as an “Appl” 95A, into the command input field 91B, the user can then click the button 75F twice such that the command input field 91B be ready for receiving new commands. It is understood that, the input of text into any type of text field can be done by a speech recognition system provided, which may be controlled by a voice input button 79M on the remote control 710. A microphone 78F is provided on the remote control 710 for receiving voice input. For example, if a user want to run an application, the user can just read the name of such application after the “command input” field 91B being ready for receiving input and after the user pressing voice input button 79M. When using speech recognition system for text input, the cursor is usually in said text-cursor mode, and the cursor icon may be set to look like a small microphone or the like.

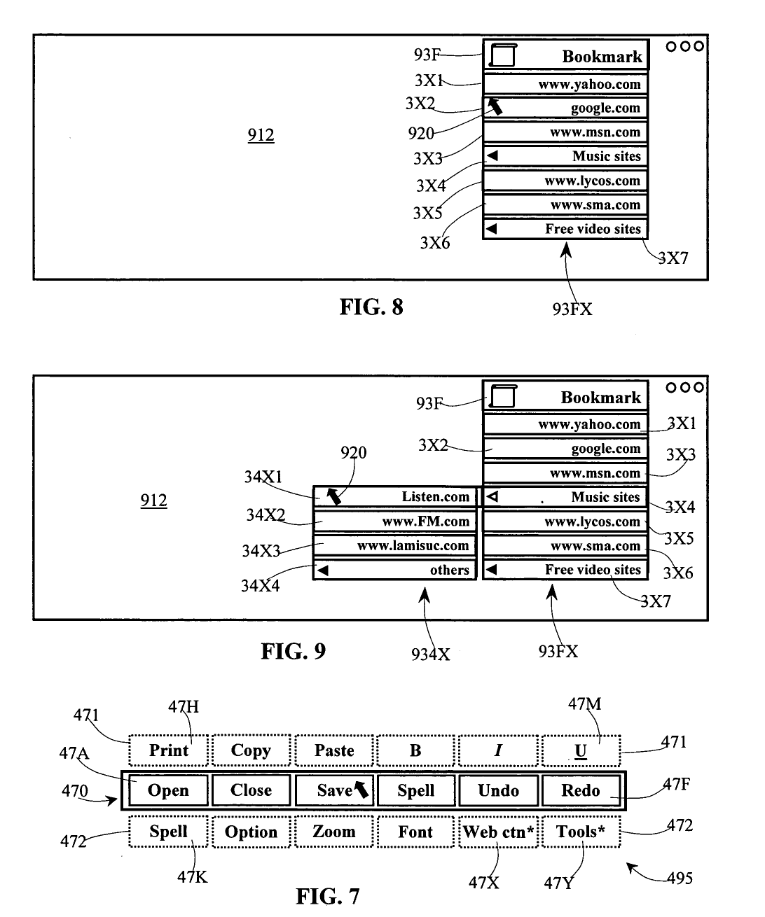

The remote control 710 also includes an “App tool” button 731 for displaying/hiding the user's favorite toolbar provided for the current window and/or window application program. In the FIG. 6 example, the current application 490 within a window 912′ is a word processor; a plurality of application-tool buttons are to be displayed within a toolbar sub-window 470 when desired; and a user's frequently used application tools or commands for such application include: “open” 47A, “close” 47B, “save” 47C, “spell” 47D, “undo” 47E, and “redo” 47F. Pressing the “App Tools” button 73I will cause the following effects, (i) if the toolbar sub-window 470 was displayed with a plurality of application-tool buttons 47A-47F therein, hiding the toolbar sub-window 470 and any contents therein; (ii) if there is no application tool button displayed, and thus the toolbar sub-window 470 was not shown, instructing the window 912′ to display a plurality of application tool buttons 47A-47F within the toolbar sub-window 470, and instructing the cursor 920 to “jump” into or be displayed at the toolbar area 470 in, for example, the leaping local mode such that, the user could easily navigate or browse through these tools 47A-47F using the rolling wheels 74V and/or 74L/74R of the remote control 710, and execute or “click on” any of these tools 47A-47F using the “Go” button 74G; Pressing the “App Tools” button 731 again will hide the toolbar 470. It is preferred that some of the number keys 720 on the remote control 710 are predefined for access to some commonly used tools through combination with the “App tool” button 731. For example, the combination of pressing the “App tool” key 731 and the number key “3” on the remote control 710 would be equivalent to clicking on the “save” icon 47C, etc. In FIGS. 6-7, the toolbar window/sub-window 470 includes one row of application tool buttons. Alternatively, the toolbar window may include more than one row of application tool buttons. The application 490 of FIG. 6 may be provided with other application tools that may not be all displayed within the toolbar window 470. In the FIG. 7 example, all of the application tool buttons provided for the application 490 of FIG. 6 are arranged in form of a 3×6 virtual matrix or rectangle 495, which includes 3 rows, i.e., row 471, the middle row 47A-F, and row 472, and 6 colunms; Some of these tools, such as the tool 47X, may be associated with or controlled by a web site; Some of them, such as the tool 47Y may be a menu that includes a listing of other tools. It is understood that, the purpose of providing such a virtual matrix arrangement is for providing instruction to the interface system regarding the sequence of displaying the application tools within the toolbar window/sub-window 470 (i.e. scrolling instruction), while the entire matrix 495, other than those elements to be displayed within the window 470, shall not be displayed in any form at all (i.e., “virtual arrangement”). With respect to vertical scrolling, after causing the display of FIG. 6 in response to pressing the “Appl. Tool” button 73I by a user, if the user wants to view other tools available for the application 490, operating the rolling wheel 74V downward will cause the first row 471 of the virtual matrix/rectangle 495 to be displayed within the window 470; operating the rolling wheel 74V upward will cause the third row 472 of the virtual matrix/rectangle 495 to be displayed within the window 470; moving the cursor 920 to an application tool button displayed within the window 470 may be done by operating the rolling wheels 74R/74L. If the matrix 495 is longer than the window 470 in the horizontal direction, the horizontal scrolling of the display within window 470 will start after the cursor 920 reaches a horizontal end of the window 470 in response to the user's operating of the rolling wheels 74R/74L.

The display button 71Q of the remote control 710 may also service as a “shortcut” for viewing and navigating menus and other information provided by the Window 912. For example, pressing the display button 71Q and then the bookmark button 73X of the remote control 710 will: (i) cause a bookmark menu 93FX of the window 912 to be displayed in its expanded mode, as shown in FIG. 8, such that a plurality of items included therein (i.e., items 3X1, 3X2, . . . and 3X6, as shown) are listed along the vertical menu-expansion direction, regardless of whether the unexpanded bookmark icon 93F was displayed thereon therebefore, and in the meantime, (ii) cause the cursor 920 to be located within the expanded bookmark menu 93FX in the “leaping local” or “continuous local” mode, so as to let user easily browse through the listed items. In FIGS. 8-9, the item 3X2 included in the menu 93FX is not an expandable lower-level submenu; So when a user moves the cursor in horizontal direction using the rolling wheel 74L/74R of the remote control 710 while the cursor 920 is located at the item 3X2, the cursor will be restricted within the boundary of the expanded menu 93FX. The item 3X4 included in the menu 93FX is an expandable lower-level submenu and includes a plurality of submenu items (i.e., 34X1, 34X2, 34X3, 34X4); Thus, when a user moves the cursor in horizontal direction using the rolling wheel 74L/74R of the remote control 710 while the cursor 920 is located at the item 3X4, it will expand the submenu 3X4 into an expanded menu 934X, which is displayed next to the menu 93FX, as shown. Similarly, (i) depressing the “Disp” key 71Q and the “Appl. Prgrms” button 75F of the remote control 710 will cause an application/program menu 93B of the window 912 to be displayed in its expanded mode such that a user can have access to all application programs provided by the computer system; and (ii) depressing the “Disp” key 71Q and the window-control button 72W of the remote control 710 will cause an window management menu 95W of the window 912 to be displayed in its expanded mode such that a user may have a brief view of all windows currently being opened, and may switch to another opened window by clicking on one of the listed items included in the expanded menu 95W displayed. Some of the frequently used application programs included in the menu 93B may be assigned with a single-digit application ID number such that a user may have quick access to such application using the “Appl. Prgrms” key 75F and the number keys 720 of the remote control 710. For example, an email client application may be assigned with an application ID No. 1, such that when a user depress the “Appl. Prgrms” key 75F and the number “1” key of the remote control 710, the name of such email application will be displayed within the “command input” field 91B; then the user can depress the “Go” button 74G of the remote control 710 after confirming that the application name shown in the “command input” field 91B is the desired application. Similarly, (i) The most recently book-marked web pages included in the bookmark menu 93F may be assigned with a bookmark ID No. 0 such that a user may have quick and sequential access to each one of these web pages by the repeated actions of pressing the Bookmark key 73X and the number key “0” of the remote control 710; (ii) A user's favorite web pages or contents may be assigned with a bookmark ID (e.g., the web pages “yahoo.com”, “msn.com”, “amazon.com”, etc. may be assigned with bookmark ID Nos. 1, 2, 3, . . . respectively) such that the user may have quick access to these web pages/contents by pressing the Bookmark key 73X and the bookmark ID No. keys, respectively, on the remote control 710. The desktop window 912 of FIG. 4 may also include a file management menu 93C that is similar to the bookmark menu 93F, or the two menus 93C and 93F may be combined. As shown, for the purpose of providing user with convenience, the menus 93A, 93B, and 93F of the window 912 are provided with graphic icons 93W, 95F, and 95X, which are essentially the same as the graphic symbols on the keys 72W, 75F, and 73X respectively of the remote control 710, which are directly related thereto.

It is appreciated that, using the combinations of pressing the “Disp” key 71Q and other buttons on the remote control 710 may provide easy access to any application tools desired. For examples: (I) Since most of the window applications include expandable menus (or menu bar) at the top that contain listings of all commands available for such application (e.g., for a word processor, the menu bar may include “File”, “Edit”, “View”, “Format”, “Tools” menus, etc.), the combination of pressing the “disp button” 71Q and the “App tools” button 73I of the remote control 710 will, (i) if the application menu bar was not displayed within the window, instruct the window 912′ to display the menus or the menu bar, (ii) cause the cursor 920 to “jump” onto such menu bar in its local mode, and (iii) expand one of the menus located by the cursor 920; When forcing the cursor 920 to the right or left, it will expand the respective neighbor menu(s); The application command located by the cursor 920 in the expanded menu may then be executed or “clicked on” by pressing the “Go” button 74G of the remote control 710; (II) The combination of pressing the “disp button” 71Q and the “App tools” button 73I and then the number “0” button of the remote control 710 will, (i) if the alert area 981 was not displayed within the window 912, instruct the window 912′ to display the alert area 981, and (ii) cause the cursor 920 to “jump” into the alert area 981 in its local mode; The user could then click on any of the icon therein using the “Go” button 74G of the remote control 710.

The following disclosure regarding method of using the remote control device 710 as a general-purpose remote-control device for control any type of household electronic device is disclosed in paragraphs [0033]-[0036] and is illustrated in FIGS. 7-8 of the U.S. patent application Ser. No. 10/340,429 filed Jan. 10, 2003 by the common Applicant, which is incorporated herein by reference.

According to another aspect of the present invention, “Indirect Control” method is applied when using the remote control 710 for a general-purpose remote control of other electronic devices. For example, in FIG. 1, the computer 30 is provided with means for transmitting/receiving remote-control signals and with the associated software system, so as to simulate the functioning of a general-purpose handheld remote control device; if the remote control 710 is to be “adjusted” to control, for examples, new devices 702, rather than adjusting the remote control 710 itself, such an “adjustment” is made to the respective software applications provided therefore and installed in the computer 30 such that, the desired (or adjusted) remote control signals be transmitted from the computer 30 to the device 702 in response to the user operation of the remote control 710, while the control signals transmitted from the remote control 710 to the computer 30 are not “adjusted” (thus “Indirect Control”).

Thus, computer system 30 of FIG. 1 is to be provided with a signal transmitter/receiver subsystem or peripheral for interacting with the remote control 710 and with the electronic appliance 702 via wireless signals. The wireless signal employed for such remote control interactions may be, preferably, RF signal. Alternatively, such wireless signal may be infrared (IR) or intermediate frequency (IF) or modulated light signal or other type of commonly used wireless signal for remote control of an electronic appliance. It is preferred that said signal transmitter/receiver subsystem is provided with means for transmitting and receiving wide range(s) of commonly used signal spectrum so as to facilitate the functioning of general-purpose remote control. In addition, each one of the electronic devices feasible for remote control, such, for examples, as the device 702 of FIG. 1, may be provided with an application icon or link in the computer system 30 that may be shown on the window desktop; When a user click on such application icon to activate the associated remote-control software application program, the electronic appliance associated therewith may then be control by the remote control device 710.

Apparently, said signal transmitter/receiver subsystem is to be provided with a digital interface system so as to interact with other components and/or processing unit of the computer 30. As a result, the computer 30 can be programmed to interact with the remote control device 710 or to control the electronic appliance 702 without providing the remote control device 710 and the electronic appliance 702 with complex digital interface. One skilled in the art would appreciate that such a method may also be applied generally to using the computer 30 to control an electronic appliance 702 without providing the appliance 702 with digital interface, and the interaction between the computer and the appliance 702 may be either one-way or two-way interaction without providing the electronic appliance with digital interface; The computer system 30 may be a mouse-window type computer system or a remote-control based computer system or other type of commonly used computer system. The computer 30 may be connected to a network, such as the Internet, such that a user can control the electronic appliance 702 from a remote location by accessing the computer 30 from another computer provided at said remote location through said network. The remote control system of the present invention may be used to control or to interact with, for examples, a clock, an exercise device such as a treadmill, an air condition system, a microwave, a TV set, a VCR or DVD player, a sound system, a radio, a washer/dryer, an electronic stove, an electronic cooking device, or an electronic toy, etc.

Since the transmitter/receiver of the computer 30 is provided with wide-range signal spectrum capability, the computer 30 may be provided with “button identification/assignment” software application program for identifying a button on a remote control and assign such button to a selected button on a general purpose remote control device. For example, if the electronic appliance 702 is provided with an original handheld remote control device 710x from the manufacture that has a button named 710x-a, and a user wants to designate a button 710-A on the general-purpose remote control device 710 to replace the functioning of the button 710x-a of the remote control device 710x; the processes of identifying the buttons 710x-a and 710-A are by simply clicking on these buttons on the remote control devices 710x and 710 respectively, and the resultant wireless signals will then be received by the computer 30 and by the button identification/assignment application program, which may, for example, assign a reference code and/or a image icon to each said buttons so identified; the button identification/assignment application program may then be used to link or associate the button 710-A to the button 710x-a such that, when the user depress or click on the button 710-A of the remote control 710, the wireless signals transmitted from computer 30 to the appliance 702 will be the same as the wireless signals transmitted thereto when the user depress the button 710x-a of the remote control device 710x; Similarly, the button 710x-a of the remote control device 710x may also be assigned to a display button of a toolbar or image shown on the computer monitor such that when a user click on said toolbar or said display button using a computer mouse, the wireless signals transmitted from the computer 30 to the appliance 702 will be the same as the wireless signals transmitted thereto when the user depress the button 710x-a of the remote control device 710x.

The following disclosures relate to the U.S. patent application Ser. No. 10/340,429 filed Jan. 10, 2003 by the common Applicant (hereinafter the “429” Application), of which the complete disclosures are incorporated fully herein by reference.

According to the 429 Application, the quality of the video images to be displayed at the client side may be improved significantly by amplifying the client-side pixel resolution and by adjusting the color characters of those newly created pixels at the client side according to the color characters of those original neighboring pixels. The conventional digital video/image compression technologies utilizes the so-called symmetric pixel resolution method, i.e., the pixel resolution of the video images to be displayed at the client side (hereinafter the “client-side pixel resolution”) is equal to (or less than) the pixel resolution of the original video images before compression (hereinafter the “server-side pixel resolution”). In addition, Discrete Cosine Transform (DCT) is the standard image compression technique. In the DCT process, the image is divided into small blocks of pixels, with each block of the pixels then undergoing a two-dimensional cosine transform to produce a two-dimensional array of transform coefficients; thereafter, the resultant transform coefficients are subject to compression by threshold and quantization operations: (i) through threshold operation, all those coefficients with magnitude smaller than a threshold value are set to zero, whereas (ii) the quantization operation involves scaling each coefficient by finite step size (i.e. quantized value) and rounding off to the nearest quantized value. Thus, the DCT compression method may be understood as transforming the original image data in the two-dimensional special domain into a two-dimensional frequency domain, or it may be understood as using vibration-type waveforms (i.e., cosine function) to represent the image data. However, unlike the sound signal, the color character F at any pixel point (xy) of a two-dimensional video image frame is not a naturally vibrating signal. Thus, in many cases, cosine function is not necessarily the best math function for representing each and every pixel block of the image frame with respect to image-compression efficiency. [Note that, it would be feasible for using the cosine function to transform the sound signal from the time domain into the frequency domain—i.e., dividing a sound signal into a plurality of sequential time block, and then using the cosine function to transform each time block into frequency domain.]

According to another aspect of the present invention, Continuous Multi-Function Transform (i.e., “CMFT”) (as compared with Discrete Cosine Transform or DCT) method is to be used for (video) image compression. In the CMFT process, a video image frame is divided into a plurality of pixel blocks (which is similar to the DCT method); thereafter, the values of the color characters F at pixel positions (xy) of each pixel block is transformed into the parameters/coefficients of a group of predefined continuous math functions/formulas. The CMFT method can be understood as using a group of continuous (instead of discrete) math functions/formula F(xy) to represent the data F of each pixel block. Said group of predefined math function/formula may include cosine function as well as any other type of math function, such as a polynomial, a straight line or plane, a constant, an exponential, etc., or any combination thereof. For example, if a pixel block is just part of a flat background, it would be more efficient to use the simple function of {F(xy)=const} than using the DCT transform. Each one of these math functions/formulas may have its boundary condition unless such boundary is the same as or is outside the respective pixel blocks.

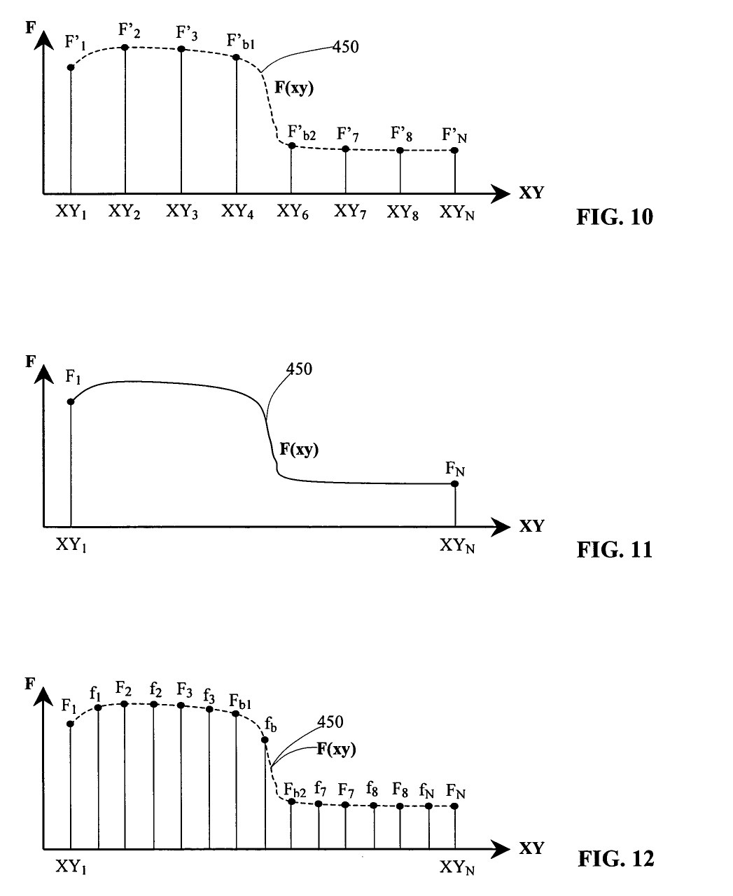

In FIG. 10, the data F′1, F′2, F′3, F′_{b1}, F′_{b2}, F′7, F′8 and F′_{N} represents the original values of color characters F at the pixel positions XY1, XY2, XY3, XY4, XY6, XY7, XY8, and XYN, respectively, of an exemplary and simplified pixel block XY1—XY_{N}. As shown in FIG. 10, the CMFT method of the present invention can be understood as finding the math function(s) {F=F(xy)} that can “draw” best line/plane 450 across through each and every one of these data, i.e., transforming these data into the parameters/coefficients of said math function(s). It is understood that, in almost all cases, it's impossible to obtain “rigorous” math method for such transform. However, there are non-rigorous or computing methods, such as statistical data fitting and the like and other computing method, available for such transform. (Other data fitting method may also be used) [Note that, The DCT transform may be understood as “rigorous” math transform. However, such DCT transform does not provide any data compression at all—as described above, the compression is actually realized by the threshold and quantization operations after DCT.] In one example, the statistical data analysis method, such as the Lest Square Fitting (LSF) used in physics and other scientific research, may be used to calculate the parameters/coefficients of the math function(s) {F=F(xy)}; These statistical data analysis method usually only provide estimation of the parameters/coefficients of the math function(s)/formula(s) used for the data fitting; The form(s) of the math function(s)/formula(s) needs to be predetermined based on prior experimentations or experience; In addition, an error bar for representing statistical error is usually provided for each and every data. If, for example, the LSF method or the like is to be used for CMFT, (i) the error bar may be artificially added to the data at each pixel point, in which case, the value of the error bars may be estimated based on the desired accuracy of the data fitting at a particular area of the video image frame; and (ii) the “statistical weight” of the data may also be artificially manipulated (e.g., in order to make sure that the data fitting is more accurate near an image-element boundary, “statistical weight” of the data near such boundary may be artificially increased). In general, a better data fitting result would require more computing power and/or more complex math function(s)/formula(s) {F=F(xy)} that has more parameters/coefficients.

Thus, through the CMFT process, the original video-image data Fs are transformed into the parameters/coefficients of a group of predetermined math functions/formulas. The data transmitted from the server to the clients will include (but not limited to): (i) Math formula/function IDs; (ii) values of the parameters/coefficients of each Math formula/function used for the data fitting; and (iii) boundary condition for each Math formula/function if such boundary is within the pixel block. Usually, if the size of the pixel block or sub-block is relatively small (e.g., 8×8 or 4×4), the data of each such block may be fitted to predetermined math function(s) without concerning other boundary conditions other than the values of the data at the edges of the pixel block. If the predetermined math function(s) is to be used to fit the data of a relatively large pixel block or parent pixel block, it might be necessary to apply a boundary condition. In regarding boundary condition, sometimes it may be necessary or convenient to use a math function to represent a portion of the boundary of an image element; Such image-boundary math function(s) may be provided with another set of math-function ID(s) such that it can be easily employed to identify the pixel range of the data that are to be fitted to a math function {F=F(xy)}. Sometimes, it may be better to apply spherical or elliptic or other coordinate system for describing said image-boundary math function than utilizing the conventional Cartesian/rectangular coordinate systems.

Therefore, as shown in FIG. 11, the data transferred from the server to the client for the pixel block of XY1—XY_{N} may be understood as continuous math function(s) or continuous data, i.e., the client computing system can create the image data for the pixel block of XY1—XY_{N} with ANY pixel resolution as desired based the math function(s) {F=F(xy)} and the parameters/coefficients thereof received from the server system. Thus, the process of pixel-resolution amplification at the client side described in the 429 Application can be done conveniently, efficiently and naturally without requesting high computing power from the client computing system if the CMFT method is employed. As shown in FIG. 12, the new data of f1, f2, . . . f_{N} for representing the increased pixel resolution are obtained by simply putting the respective pixel positions thereof into the formula(s)/function(s) of {F=F(xy)}. It is also appreciated that, by using the CMFT method, the pixel resolution of the video image frame to be displayed at the client side may not be evenly distributed throughout the image frame.

Naturally, the embodiments of the present invention are not limited to the above-described examples or to those examples shown in the drawings. It will be understood that various substitutions, rearrangements and other changes to the forms and details of the examples can be made by those skilled in the art without departing from the scope of the invention as set forth in the annexed claims.

What is claimed is:

1. In a computing system having an application program executed by the computing system and displayed within an application window on a display of said computing system, said application program including application tools that are represented by application-tool buttons respectively that are to be displayed within a predefined application-tool area when desired, said computing system including a cursor to be displayed on said display when desired for indicating functioning and user's manipulation of a user-input device, a method comprising the steps of:
In response to receiving a user input from said user-input device,
Determining whether any of said application-tool buttons are displayed within said application-tool area,
When it is determined that there is no application-tool button displayed within said application-tool area: displaying a plurality of said application program's application-tool buttons within said application-tool area, causing said cursor to be displayed within said application-tool area, and browsing through said application-tool buttons when a cursor-movement input is received.

2. The method as set forth in claim 1, wherein said application-tool area is a window, which is to be visible on said display when any of said application-tool buttons are displayed therein, said method further comprising the step of: when it is determined that there is at least one of said application-tool buttons displayed within said application-tool area and thus that the application-tool area window is visible on said display, hiding said application-tool area window.

3. The method of claim 1, further comprising the step of: causing said cursor to be in a local mode such that movement of the cursor is restricted within said application-tool area.

4. The method as set forth in claim 1, wherein said application-tool buttons are arranged in form of a virtual geometric shape so as to provide instructions for sequentially displaying said application-tool buttons within said application-tool area, whereby said virtual geometric shape is to be partially displayed within said application-tool area when desired, and wherein said step of browsing through comprises the step of:
In response to receiving a cursor-movement input for directing the cursor to move in a desired direction,
Determining whether there is substantial space for moving the cursor in said desired direction before the cursor encountering an external boundary of said application-tool area;
When it is determined that there is substantial space for moving the cursor in said desired direction before the cursor encountering the external boundary of said application-tool area, moving said cursor in said desired direction;
When it is determined that there is no substantial space for moving the cursor in said desired direction before the cursor encountering the external boundary of said application-tool area, scrolling said application-tool area's content displayed.

5. The method as set forth in claim 4, wherein said application-tool buttons are arranged in such a way that said virtual geometric shape is a virtual rectangle such that said applications-tool buttons form a plurality of virtual rows and columns, and wherein said step of scrolling comprises the steps of:
Determining whether in said desired direction there is any virtually hidden application-tool buttons outside said application-tool area's boundary;
When it is determined that in said desired direction there is virtually hidden application-tool buttons outside said application-tool area's boundary, moving said hidden application-tool buttons into said application-tool area for display.

6. The method as set forth in claim 5, wherein two opposite sides of said virtual rectangle are virtually attached to one another such that said virtual rectangular forms a virtual cylinder so as to provide continuous scrolling experience in a desired scrolling direction.

7. The method as set forth in claim 1, 2, 3, 4, 5, or 6, wherein said application program is a spreadsheet or the like, a web browser or the like, a media player or the like, a word processor or the like, a CAD application or the like, an image editor or the like, an image viewer or the like, a motion-picture editor or the like, motion-picture viewer or the like, a web publishing application or the like, a document reader or the like, an Instant Messaging client or the like, an Instant-Messaging-related application or the like, an E-mail client or the like, or an E-mail-related application or the like.

8. The method as set forth in claim 1, wherein said user-input device is a handheld remote-control device.

9. In a computing system having an expandable menu for display on a display of said computing system when desired and a cursor to be displayed on said display when desired for indicating functioning and user's manipulation of a user-input device, a method comprising the steps of:
In response to receiving a user input from said user-input device,
Displaying said menu in its expanded mode on said display such that a plurality of items included in said menu are displayed on said display; and
Causing said cursor to be visibly located on said expanded menu.

10. The method as set forth in claim 9, wherein said step of displaying is to be performed before said step of causing.

11. The method as set forth in claim 9, wherein said step of displaying is to be performed after said step of causing.

12. The method of claim 9, further comprising the step of: causing said cursor to be in a local mode such that movement of the cursor is restricted within the expanded menu displayed.

13. The method as set forth in claim 9, 10, 11, or 12, wherein said user-input device is a handheld remote-control device.

14. In a computing system having a cursor for indicating functioning and user's manipulation of a user-input device and an expandable menu, said menu being displayed in its expanded mode on a display of said computing system such that a plurality of items included therein are displayed and are listed along a menu-expansion direction on said display, said cursor being visible on said display and being located within said expanded menu, a method comprising the steps of:
In response to a cursor-movement input from said user-input device for moving the cursor in a desired direction,
Determining whether there is substantial space for moving the cursor in said desired direction before the cursor encountering an external boundary of said expanded menu,
When it is determined that, there is substantial space for moving the cursor in said desired direction before the cursor encountering the external boundary of said expanded menu, moving said cursor in said desired direction;
When it is determined that, there is no substantial space for moving the cursor in said desired direction before the cursor encountering the external boundary of said expanded menu, navigating the item currently located by the cursor.

15. The method as set forth in claim 14, wherein said item currently located by the cursor is an expandable submenu including a plurality of submenu items, and wherein said step of navigating comprises the step of:
Determining whether said desired direction is substantially perpendicular or parallel to said menu-expansion direction,
When it is determined that said desired direction is substantially perpendicular to said menu-expansion direction, expanding said submenu such that a plurality of submenu items included therein are displayed on said displayed, and moving said cursor to said expanded submenu.

16. The method of claim 15, further comprising the step of: When it is determined that said desired direction is substantially parallel to said menu-expansion direction, maintaining said cursor's position near said external boundary of said expanded menu such that said cursor-movement input does not cause the cursor to move beyond said external boundary.

17. The method as set forth in claim 14, wherein said item currently located by the cursor is not an expandable submenu and does not include any submenu item, and wherein said step of navigating comprises the step of: maintaining said cursor's position near said external boundary of said expanded menu such that said cursor-movement input does not cause the cursor to move beyond said external boundary.

18. The method as set forth in claim 14, 15, 16, or 17, wherein said user-input device is a handheld remote-control device.

19. A method comprising the steps of:
In response to receiving a user input,
Displaying an display item within a predefined area on a display of a computer system, and
Causing a cursor of said computer system to be displayed within said predefined area on said display.

20. The method as set forth in claim 19, wherein said step of displaying is to be performed before said step of causing.

21. The method as set forth in claim 19, wherein said step of displaying is to be performed after said step of causing.

22. The method as set forth in claim 19, wherein said display item includes a plurality of application-tool buttons of an application program executed by said computer system.

23. The method as set forth in claim 19, wherein said display item is a pulled-down menu.
